(19) United States
(12) Patent Application Publication
(10) Pub. No.: US 2015/0227219 A1
(43) Pub. Date: Aug. 13, 2015

(54) PORTABLE TERMINAL AND CURSOR POSITION CONTROL METHOD

(71) Applicant: KYOCERA Corporation, Kyoto-shi (JP)

(72) Inventors: Seiji Yamada, Daito-shi (JP); Atsushi Suzuki, Nishinomiya-shi (JP); Seiya Sakamoto, Shijonawate-shi (JP)

(21) Appl. No.: 14/424,990

(22) PCT Filed: Aug. 28, 2013
(86) PCT No.: PCT/JP2013/072975

§ 371 Date: Feb. 27, 2015

(30) Foreign Application Priority Data
Aug. 28, 2012 (JP) 2012-187476

(51) Int. Cl. G06F 3/0354; G06F 3/0484; H04M 1/02; G06F 3/038

(52) U.S. Cl. CPC G06F 3/03547; G06F 3/038; G06F 3/04842; H04M 1/0266

(57) ABSTRACT

A mobile phone 10 comprises a display 14, a touch panel 16, etc. A sentence is displayed on the display 14 by means of a sentence producing function, for example. If a user performs a selection operation to the sentence in this state, it is rendered in a state where a character string that is arbitrarily selected is sandwiched by a first cursor and a second cursor. If a slide operation in a rightward direction is performed when a character string being in a selected state is a single character, the first cursor is fixed and the second cursor is moved in the rightward direction. On the other hand, if a slide operation in a leftward direction is performed, the second cursor is fixed and the first cursor is moved in the leftward direction.

### FIELD OF ART

The invention relates to a portable terminal and a cursor position control method, and more specifically, a portable terminal and a cursor position control method that data being displayed can be selected.

### BACKGROUND ART

A portable terminal that data being displayed can be selected is known. A touch panel control apparatus is a mobile phone that includes a touch panel as an example. The touch panel includes a display means on which a character is displayed. If selecting the character, for example, a user may perform a touch operation to the character being displayed. Specifically, the user makes a finger touch a start point of a range to be copied, and move to an end point of the range to be copied while keeping the touch, and then, release from a screen, whereby a selection range of the character to be copied.

### SUMMARY OF THE INVENTION

### Problem to be Solved by the Invention

However, if the above-described touch panel control apparatus is applied to a mobile phone, there is a case where a finger is larger than a character being displayed. In such a case, it is difficult for a user to touch a target position, and therefore, the selection range may not be designated as the user thinks.

Therefore, it is a primary object of the invention to provide a novel portable terminal and cursor position control method.

It is another object of the invention to provide a portable terminal and cursor position control method, capable of easily designating a selection range.

### Means for Solving the Problem

A first aspect of the invention is a portable terminal having a display module and a touch panel that is provided on the display module and detects a touch operation, wherein when dada that is being displayed on the display module is selected by a touch operation, selected data is sandwiched by a first cursor and a second cursor, comprising: a first fixing module operable to fix the first cursor when a touch operation moving in a first direction is performed in a state where the selected data is sandwiched by the first cursor and the second cursor; and a first moving module operable to move the second cursor in the first direction when the touch operation moving in the first direction is performed in a state where the first cursor is fixed.

A second aspect of the invention is a portable terminal having a display module and a touch panel that is provided on the display module and detects a touch operation, wherein when dada that is being displayed on the display module is selected by a touch operation, selected data is sandwiched by a first cursor and a second cursor, comprising: a first moving module operable to move only the second cursor in a first direction when a touch operation moving in the first direction is performed in a state where the selected data is sandwiched by the first cursor and the second cursor; and a second moving module operable to move only the first cursor in a second direction when a touch operation moving in the second direction is performed in a state where the selected data is sandwiched by the first cursor and the second cursor.

A third aspect of the invention is a cursor position control method in a portable terminal having a display module and a touch panel that is provided on the display module and detects a touch operation, wherein when dada that is being displayed on the display module is selected by a touch operation, selected data is sandwiched by a first cursor and a second cursor, a processor of the portable terminal performing steps of: a fixing step operable to fix the first cursor when a touch operation moving in a first direction is performed in a state where the selected data is sandwiched by the first cursor and the second cursor; and a moving step operable to move the second cursor in the first direction when a touch operation moving in the first direction is performed in a state where the first cursor is fixed.

### Advantage of the Invention

According to the invention, it is possible to easily designate a selection range.

The above described objects and other objects, features, aspects and advantages of the invention will become more apparent from the following detailed description of the invention when taken in conjunction with the accompanying drawings.

### BRIEF DESCRIPTION OF THE DRAWINGS

FIG. 1 an appearance view showing a mobile phone according to an embodiment of the invention.

FIG. 2 is a schematic view showing electric structure of the mobile phone shown in FIG. 1.

FIG. 3 is a schematic view showing an example of a screen of a sentence producing function displayed on a display shown in FIG. 1.

FIG. 4 schematically shows an example of an editing operation that is performed to the screen of the sentence producing function shown in FIG. 3, wherein FIG. 4(A) shows an example of a state where a touch operation is performed at an arbitrary position, FIG. 4(B) shows an example of a state where a popup that includes an editing menu is being displayed, FIG. 4(C) shows an example of a touch operation to the popup, and FIG. 4(D) shows an example of a state where a character string being in a selected state is sandwiched by two cursors.

FIG. 5 schematically shows an example of an operation to change a cursor position shown in FIG. 4, wherein FIG. 5(A) shows a state where a slide operation in a rightward direction is performed and FIG. 5(B) shows a state where a second cursor moves in the rightward direction.

FIG. 6 schematically shows another example of the operation to change a cursor position shown in FIG. 4, wherein FIG. 6(A) shows a state where a slide operation in a leftward direction is performed and FIG. 6(B) shows a state where a first cursor moves in the leftward direction.

FIG. 7 schematically shows another example of the editing operation that is performed to the screen of the sentence producing function shown in FIG. 3, wherein FIG. 7(A) shows an example of a touch operation to a character string being in a selected state and FIG. 7(B) shows an example of a state where a popup that includes keys corresponding to editing processing is being displayed.

FIG. 8 is a schematic view showing an example of a memory map of a RAM shown in FIG. 2.

FIG. 9 is a flowchart showing an example of sentence producing processing by a processor shown in FIG. 2.

FIG. 10 is a flowchart showing an example of cursor position control processing by the processor shown in FIG. 2.

FIG. 11 schematically shows a further example of an operation to change a cursor position shown in FIG. 4, wherein FIG. 11(A) shows a state where a slide operation in a rightward direction is performed, FIG. 11(B) shows a state where a touch position is overlapped with displaying of a second cursor, and FIG. 11(C) shows a state where the second cursor moves in the rightward direction.

FIG. 12 schematically shows the other example of an operation to change a cursor position shown in FIG. 4, wherein FIG. 12(A) shows a state where a slide operation in a leftward direction is performed, FIG. 12(B) shows a state where a touch position is overlapped with displaying of a first cursor, and FIG. 12(C) shows a state where the first cursor moves in the leftward direction.

FIG. 13 is a flowchart showing another example of the cursor position control processing by the processor shown in FIG. 2.

### FORMS FOR EMBODYING THE INVENTION

### First Embodiment

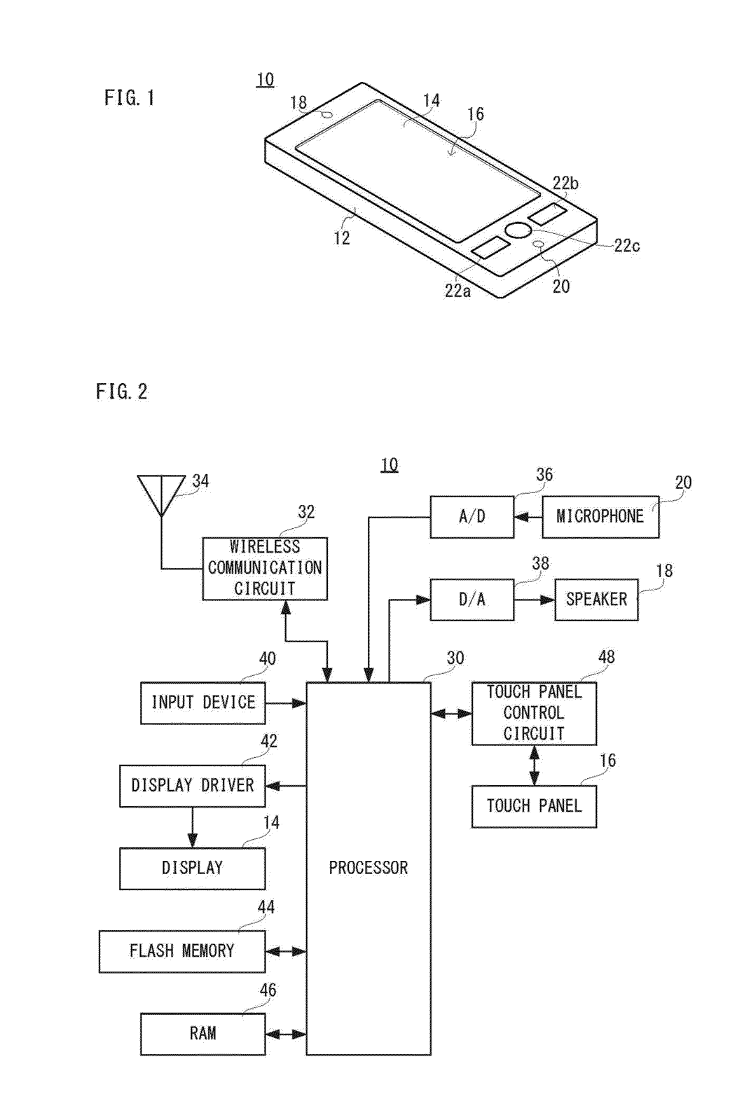

With referring to FIG. 1, a mobile phone 10 of an embodiment according to the invention is a smartphone as an example, and includes a longitudinal flat rectangular housing 12. However, it is pointed out in advance that the invention can be applied to an arbitrary portable terminal such as a tablet terminal, a PDA, etc.

A display 14 that functions as a display module and may be a liquid crystal, organic EL or the like is provided on a main surface of the housing 12. A touch panel 16 is provided on the display 14. Therefore, in the mobile phone 10 of this embodiment, the most part of an input operation excepting an input by an operation of a hardware key described later is performed through the touch panel 16.

A speaker 18 is housed in the housing 12 at one end of a longitudinal direction on a side of the main surface, and a microphone 20 is housed at the other end in the longitudinal direction on the side of the main surface.

As hardware keys constituting an input operating module together with the touch panel 16, a call key 22a, an end key 22b and a menu key 22c are provided, in this embodiment.

For example, a user can input a telephone number by performing a touch operation by the touch panel 16 to a dial key (not shown) displayed on the display 14, and start a telephone conversation by operating the call key 22a. If the end key 22b is operated, the telephone conversation can be ended. In addition, by long-depressing the end key 22b, it is possible to turn on/off a power supply of the mobile phone 10.

If the menu key 22c is operated, a menu screen is displayed on the display 14, and in such a state, by performing a touch operation by means of the touch panel 16 to software keys, menu icons or the like being displayed on the display 14, it is possible to select a menu and to determine such a selection.

With referring to FIG. 2, the mobile phone 10 of the embodiment shown in FIG. 1 includes a processor 30 that is called a computer or CPU, and so on. The processor 30 is connected with a wireless communication circuit 32, an A/D converter 36, a D/A converter 38, an input device 40, a display driver 42, a flash memory 44, a RAM 46, a touch panel control circuit 48, etc.

The processor 30 is in charge of entire control of the mobile phone 10. A whole or part of a program set in advance in the flash memory 44 is, in use, developed or loaded into the RAM 46 that functions as a storing module, and the processor 30 operates in accordance with the program developed in the RAM 46. In addition, the RAM 46 is further used as a working area or buffer area for the processor 30.

The input device 40 includes the touch panel 16 and the hardware keys 22a, 22b and 22c shown in FIG. 1, and constitutes an operating module or input module. Information (key data) of the hardware key that the user operated is input to the processor 30.

The wireless communication circuit 32 is a circuit for transmitting and receiving a radio wave for a telephone conversation, an e-mail, etc. In the embodiment, the wireless communication circuit 32 is a circuit for performing a wireless communication in a CDMA system. If the user instructs an outgoing call (telephone call) by operating the input device 40, for example, the wireless communication circuit 32 performs telephone call processing under instructions of the processor 30 and outputs a telephone call signal via the antenna 34. The telephone call signal is transmitted to a telephone at the other end of line through a base station and a communication network. Then, when incoming call processing is performed in the telephone at the other end of line, a communication-capable state is established and the processor 30 performs telephone conversation processing.

The microphone 20 shown in FIG. 1 is connected to the A/D converter 36, and a voice signal from the microphone 20 is converted into digital voice data by the A/D converter 36 to be input to the processor 30. On the other hand, the speaker 18 is connected to the D/A converter 38. The D/A converter 38 converts digital voice data into a voice signal to apply to the speaker 18 via an amplifier. Therefore, a voice of the voice data is output from the speaker 18.

The display driver 42 is connected with the display 14 shown in FIG. 1, and therefore, the display driver 42 displays on the display 14 a video or image according to video or image data that is output from the processor 30. That is, the display driver 42 controls displaying by the display 14 that is connected to the display driver 42 under instructions of the processor 30. The display driver 42 includes a video memory that temporarily stores the image data to be displayed. In addition, the display 14 is provided with a backlight that includes a light source of an LED or the like, for example, and the display driver 42 controls, according to the instructions of the processor 30, brightness, lighting on/off of the backlight.

The touch panel 16 shown in FIG. 1 is connected to the touch panel control circuit 48. The touch panel control circuit 48 applies to the touch panel 16 a necessary voltage or the like and inputs to the processor 30 a touch start signal indicating a start of a touch by the user to the touch panel 16, a touch end signal indicating an end of a touch by the user, and coordinate data indicating a touch position that the user touches. Therefore, the processor 30 can determine the user touches to which icon or key based on the coordinate data.

In the embodiment, the touch panel 16 is of an electrostatic capacitance system that detects a change of an electrostatic capacitance between electrodes, which occurs when an object such as a finger is in close to a surface of the touch panel 16. The touch panel 16 detects that one or more fingers are brought into contact with the touch panel 16, for example. Therefore, the touch panel 16 is also called a pointing device. The touch panel control circuit 48 functions as a detecting module, and detects a touch operation within a touch-effective range of the touch panel 16, and outputs coordinate data indicative of a position of the touch operation to the processor 30. That is, the user inputs to the mobile phone 10 an operation position, an operation direction and so on through a touch operation to the surface of the touch panel 16.

A tap operation, a long tap operation, a flick operation, a slide operation, etc. are included in the touch operation of this embodiment.

The tap operation is an operation that a finger is brought into contact with the surface of the touch panel 16, and then, the finger is lifted (released) from the surface of the touch panel 16 within a short time. The long tap operation is an operation that a finger is continued to be brought into contact with the surface of the touch panel 16 for a predetermined time period or more, and then, the finger is released from the surface of the touch panel 16. The flick operation is an operation that a finger is brought into contact with the surface of the touch panel 16, and the finger is flicked in an arbitrary direction. The slide operation is an operation that a finger is moved in an arbitrary direction while being kept to be brought into contact with the surface of the touch panel 16, and then, the finger is released from the surface of the touch panel 16.

It should be noted that in the above-described slide operation, a slide operation that a finger is brought into contact with an object being displayed on the surface of the display 14 and moves the object, that is, a so-called drag operation is also included. An operation that a finger is released from the surface of the touch panel 16 after the drag operation is called a drop operation. In addition, in the following description, there is an occasion that the touch operation, the long tap operation, the flick operation, the slide operation, the drag operation and the drop operation may be described with omitting the word “operation”, respectively.

Furthermore, the mobile phone 10 has a sentence producing function that a sentence can be arbitrarily produced in addition to the telephone function.

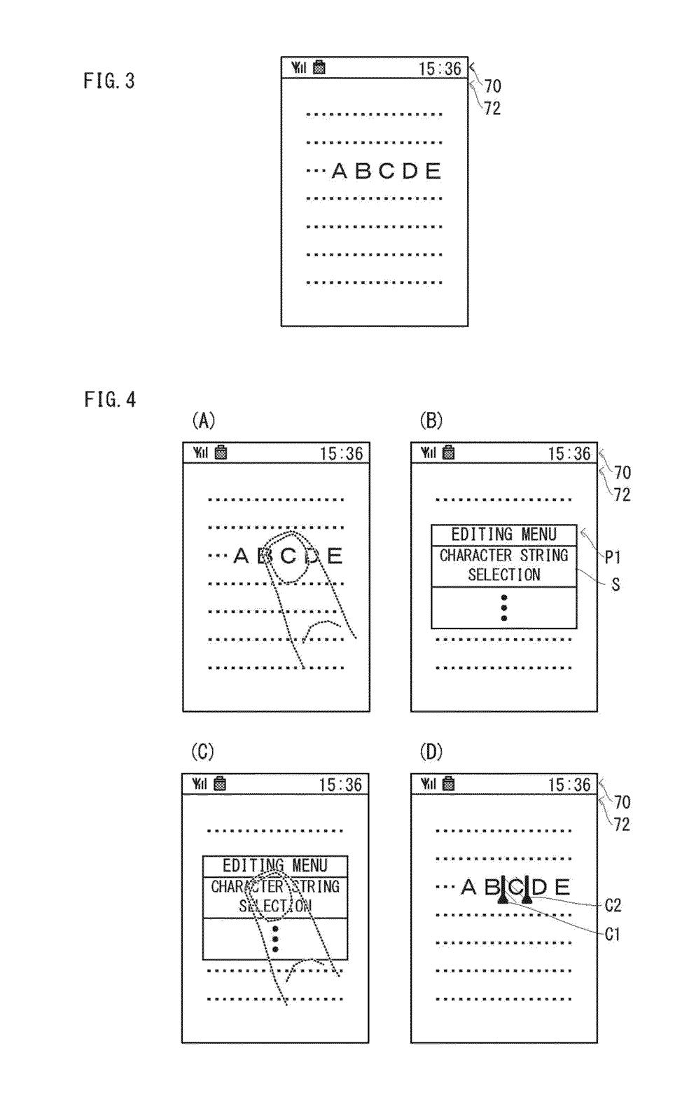

With reference to FIG. 3, the display 14 includes a status displaying area 70 and a function displaying area 72. A sentence that is produced by the sentence producing function is displayed in the function displaying area 72. In the status displaying area 70, an icon (picto) showing a radio-wave receiving status by the antenna 34, an icon showing a residual battery capacity of a secondary battery and a day and time are displayed. In the function displaying area 72, a sentence including a character string “ABCDE”, for example is being displayed.

With reference to FIGS. 4(A) and 4(B), if a tap is performed to a sentence being displayed, a popup P1 corresponding to an editing menu. The popup P1 includes a selection key S for selecting a character string, etc. If a tap is performed to the selection key S, a clause (character string) that includes a character that is tapped to display the popup P1 is selected.

With reference to FIGS. 4(C) and 4(D), if a character “C” is touched and the popup P1 is displayed, a clause including the character “C”, only the character “C” becomes to be in a selected state. Then, in this embodiment, a character string being in a selected state is arranged with a first cursor C1 at a left side and a second cursor at a right side. That is, the character string being in a selected state is rendered to be sandwiched by the first cursor C1 and the second cursor C2.

Here, the user can arbitrarily change a range of selected character string (selected range) by dragging the first cursor C1 or the second cursor C2 to drop at an arbitrary position.

However, if the character string being in a selected state is a single character (single selectable unit), the first cursor C1 and the second cursor C2 are displayed in a neighboring state. In such a state, even if the user performs a touch operation to intend to drag the first cursor C1, the second cursor C2 may be dragged. That is, there is a possibility that the cursor C cannot be dragged as the user intends.

Therefore, in this embodiment, if a single character is in a selected state, the position of the cursor C, that is, the selected range can be changed by a slide operation.

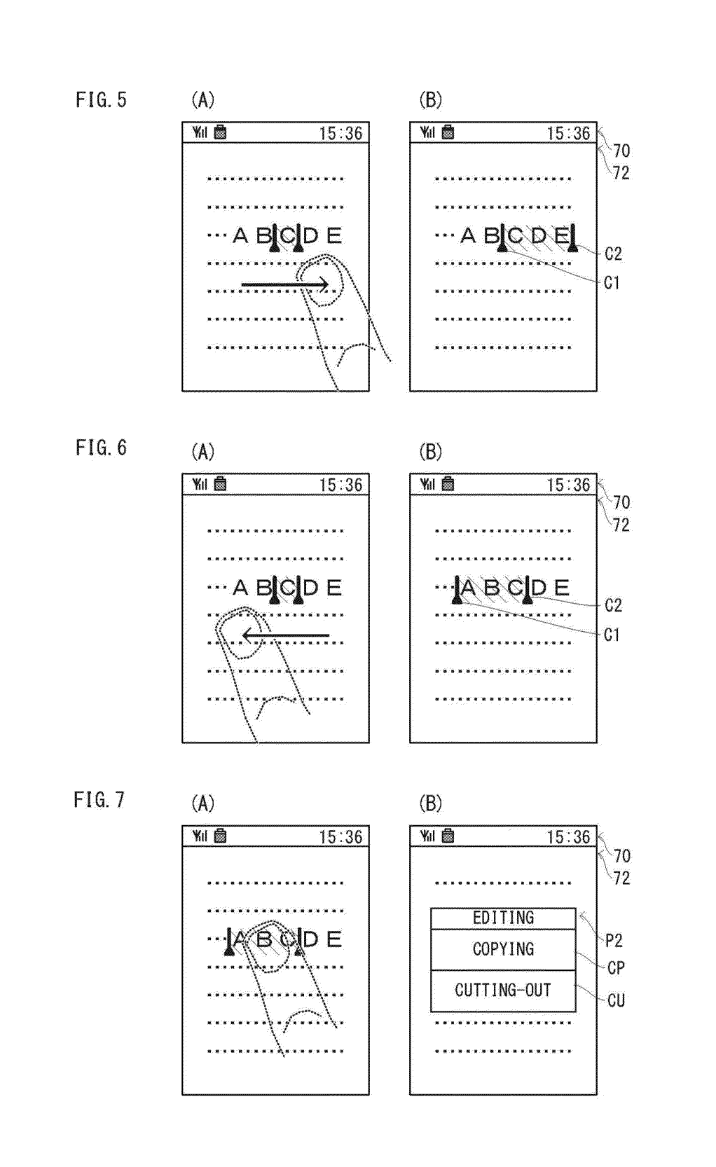

With reference to FIGS. 5(A) and 5(B), if the second cursor C2 is to be moved toward a right side, when the user performs a slide in a rightward direction at an arbitrary position, the second cursor C2 moves in the rightward direction. On the other hand, with reference to FIGS. 6(A) and 6(B), if the first cursor C1 is to be moved toward a left side, when the user performs a slide in a leftward direction at an arbitrary position, the first cursor C1 moves in the leftward direction.

At this time, a moving amount of the cursor C is determined according to a moving amount of the slide. In addition, a cursor not moving, that is, the first cursor C1 in FIG. 5 or the second cursor C2 in FIG. 6 is fixed upon detection of the slide.

Accordingly, since the user can easily change a position of the cursor C, the user can arbitrarily designate a range of selected data. Especially, the user can individually move the left and right cursors C.

In addition, as a method of fixing the cursor C, it is thinkable that processing to change a displaying position of the cursor C may be invalidated or a touch operation to the cursor C may be invalidated.

With reference to FIGS. 7(A) and 7(B), if a touch operation is performed to a character string being in a selected state, a popup P2 that includes keys corresponding to editing processing is displayed. The popup P2 includes a copy key CP for copying a character string being in a selected state and a cut key CU for cutting-out a character string being in a selected state. The user can copy or cut-out a character string being in a selected state by performing a touch operation to an arbitrary key.

In addition, the popups P1 and P2 are non-displayed if a touch is performed to an outside thereof.

Furthermore, the cursor C may be moved not only in a left and right direction but in an up and down direction. If a slide is performed in a downward direction, for example, the second cursor C2 moves in the downward direction. If a slide is performed in an upward direction, the first cursor C1 moves in the upward direction. Furthermore, the left and right direction and the up and down direction may be put together with each other by once slide. The user may move a finger in the upward direction without releasing after moving in the leftward direction, for example. The user may move a finger in the downward direction without releasing after moving in the rightward direction, for example. In such cases, the cursor C moves corresponding to respective directions.

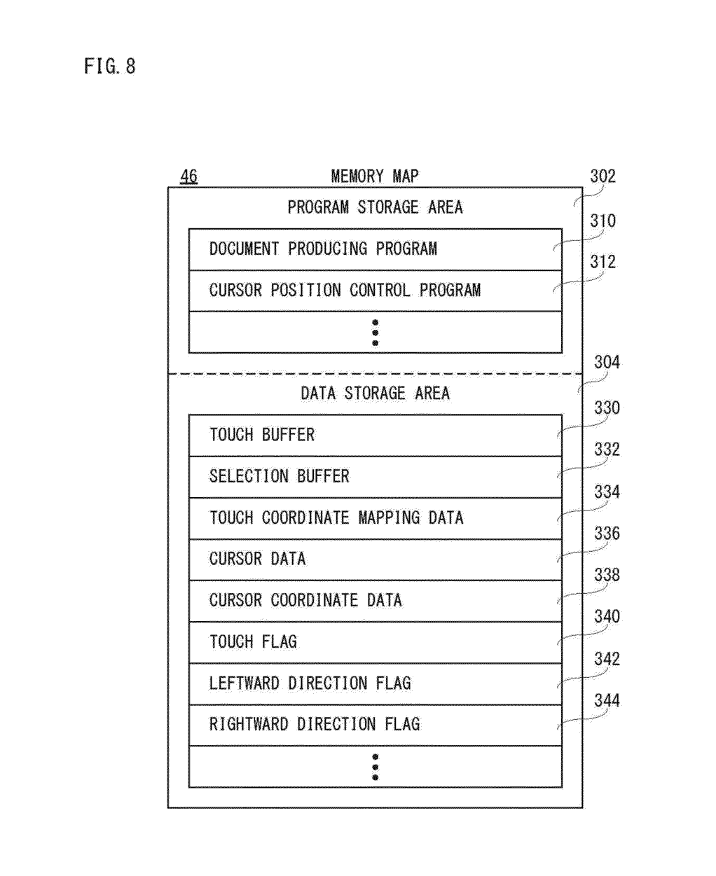

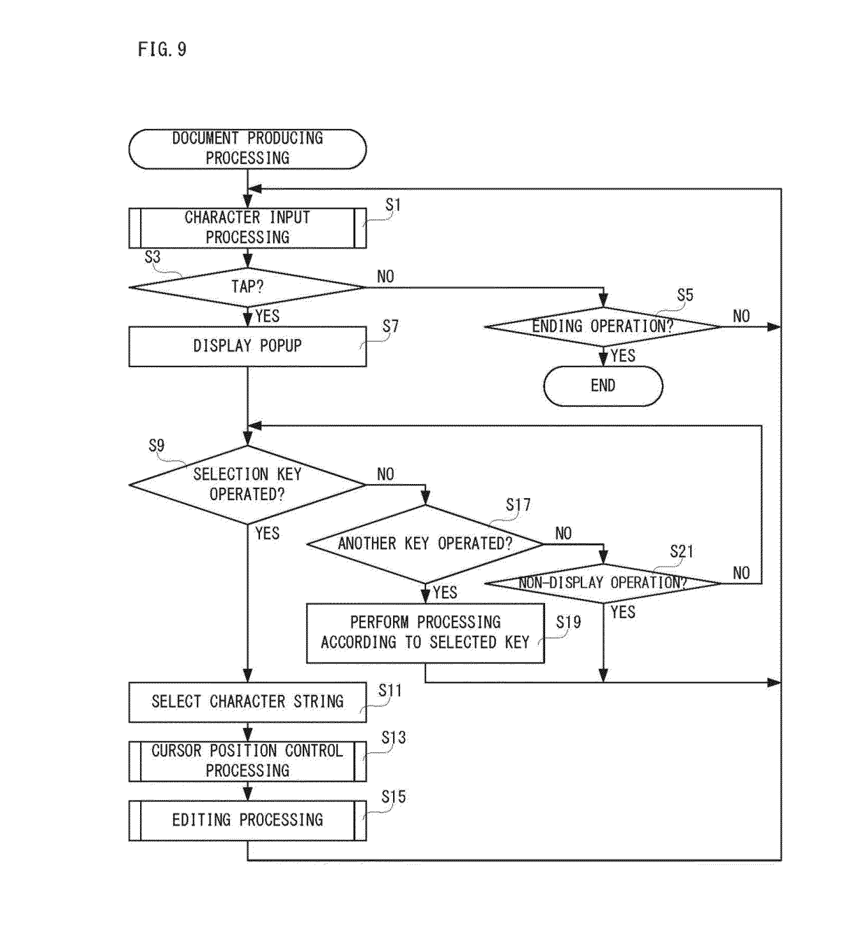

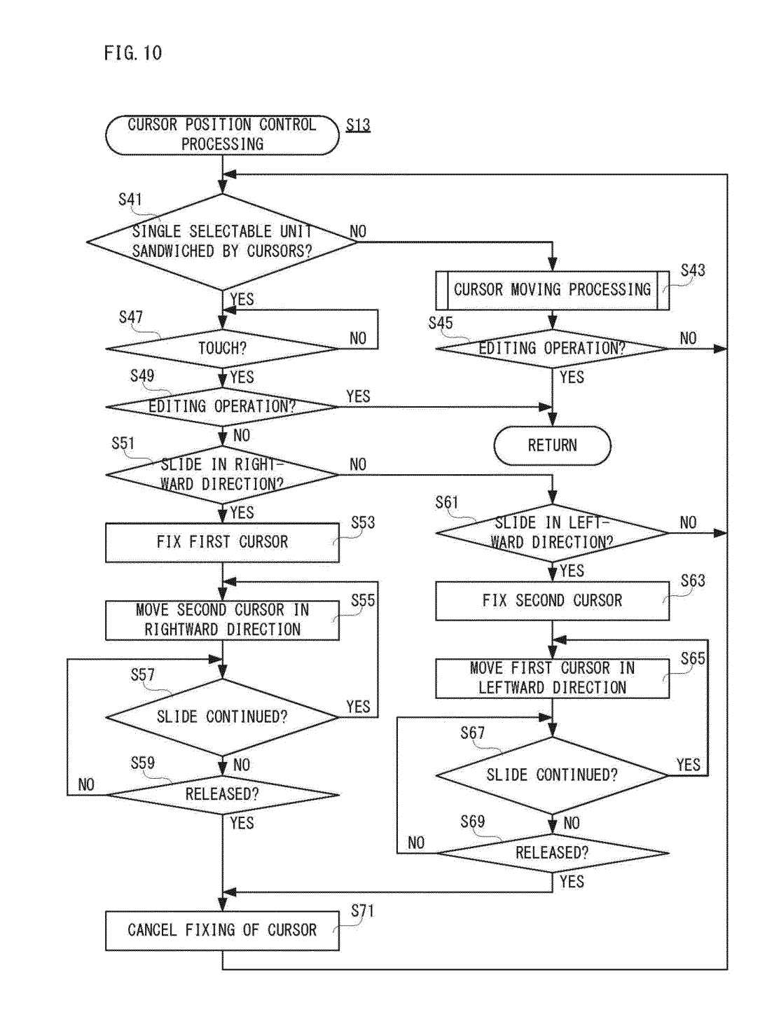

Although the feature of the embodiment is outlined in the above, in the following, the embodiment will be described in detail using a memory map of the RAM 46 shown in FIG. 8 and flowcharts shown in FIGS. 9 and 10.

With reference to FIG. 8, a program storage area 302 and a data storage area 304 are formed in the RAM 46 shown in FIG. 2. The program storage area 302 is an area for reading and storing (developing) a part or whole of program data that is set in advance in the flash memory 44 (FIG. 2), as described previously.

The program storage area 302 includes a sentence producing program 310 for performing a sentence producing function and a cursor position control program 312 for controlling a displaying position of a cursor C. In addition, the programs for executing a telephone function, an answerphone function, a mail function, an alarm function, etc. are also included in the program storage area 302.

The data storage area 304 of the RAM 46 is provided with a touch buffer 330 and a selection buffer 332, and stored with touch coordinate mapping data 334, cursor data 336 and cursor coordinate data 338. In addition, a touch flag 340, a leftward direction flag 342 and a rightward flag 344 are also provided in the data storage area 304.

The touch buffer 330 is stored with touch coordinate data that is output from the touch panel control circuit 48. The selection buffer 332 is temporarily stored with data of a character string being in a selected state. The touch coordinate mapping data 334 is data for mapping the touch coordinate of the touch operation and the displaying coordinate of the display 14 with each other. That is, a result of the touch operation that is performed to the touch panel 16 is reflected in the displaying of the display 14 based on the touch coordinate mapping data 334.

The cursor data 336 is image data for displaying a first cursor C1 and a second cursor C2. The cursor coordinate data 338 includes displaying coordinate data of the cursor being displayed. Therefore, the processor 30 determines whether a touch operation is to the cursor C based on the touch coordinate in the touch buffer 330 and the cursor coordinate data in the cursor coordinate data 338.

The touch flag 340 is a flag for determining whether a touch is being performed to the touch panel 16. The touch flag 340 is constructed by a 1-bit register, for example. If the touch flag 340 is turned-on (true), a data value “1” is set in the register. On the other hand, if the touch flag 340 is turned-off (false), a data value “0” is set in the register. Furthermore, the touch flag 340 is switched to on or off based on the output of the touch panel control circuit 48.

The leftward direction flag 342 is a flag for determining whether a direction of a slide operation is a leftward direction. The rightward direction flag 344 is a flag for determining whether a direction of a slide operation is a rightward direction. Since each of the leftward direction flag 342 and the rightward direction flag 344 has approximately the same structure as that of the touch flag 340, a detailed description of the structure thereof is omitted for simplifying.

The data storage area 304 is stored with data of a character string that is stored by a copying or a cutting-out, image data that is displayed in the standby state, etc., and provided with counters and flags necessary for an operation of the mobile phone 10.

The processor 30 processes a plurality of tasks including sentence producing processing shown in FIG. 9, cursor position control processing shown in FIG. 10, etc. in parallel with each other under controls of Linux (registered trademark)-base OS such as Android (registered trademark) and REX, or other OSs.

The sentence producing processing is started when an operation for performing the sentence producing function is performed. In a step S1, the processor 30 performs character input processing. That is, a character string that is input according to an input operation by the user is displayed on the display 14. In addition, an input method may be a direct input using a virtual keyboard or a voice input.

Subsequently, it is determined, in a step S3, whether a tap is performed. That is, it is determined whether the touch flag 340 is turned on and then turned off. If “NO” is determined in the step S3, that is, if a tap is not performed, the processor 30 determines, in a step S5, whether an ending operation is performed. That is, it is determined whether an operation for ending the sentence producing processing is performed. If “YES” is determined in the step S5, that is, if the end key 22b is operated, for example, the processor 30 terminates the sentence producing processing. On the other hand, if “NO” is determined in the step S5, that is, if the ending operation is not performed, the processor 30 returns to the processing of the step S1.

If “YES” is determined in the step S3, that is, if a tap is performed, the processor 30 displays a popup P1 in a step S7. As shown in FIG. 4(B), for example, the popup P1 including an editing menu is displayed. Subsequently, the processor 30 determines, in a step S9, whether a selection key S is operated. If “YES” is determined in the step S9, that is, if a touch operation is performed to the selection key S, the processor 30 selects a character string in a step S11. If the tap is performed at a position shown in FIG. 4(A), for example and the popup P1 is displayed, a clause that includes a character “C” at a touch position is rendered in a selected state as shown in FIG. 4(D). In addition, a character string being in a selected state is stored in the selection buffer 332.

Subsequently, the processor 30 returns to the processing of the step 51 after performing cursor position control processing in a step S13 and performing editing processing in a step S15. For example, in the step S13, a displaying position of a cursor C is changed, and in the step S15, a popup P2 including keys corresponding to the editing processing is displayed. In addition, the cursor position control processing will be described in detail using a flowchart shown in FIG. 10, and therefore, a description is omitted here.

If “NO” is determined in the step S9, that is, if the selection key S is not operated, the processor 30 determines, in a step S17, whether another key is operated. That is, it is determined whether a key other than the selection key S out of the keys being displayed in the popup P1. If “YES” is determined in the step S17, that is, if another key is operated, the processor 30 performs processing based on a selected key in a step S19. If a key (a paste key) for inserting a character string that is copied is operated, for example, the copied character string is inserted based on the touch position at a time that the popup P1 becomes to be displayed. Then, the processor 30 returns to the step S1 when the processing of the step S19 is completed.

In addition, if “NO” is determined in the step S17, that is, if no other key is operated, the processor 30 determines, in a step S21, whether a non-display operation is performed. It is determined whether a touch is performed outside the popup P1, for example. If “NO” is determined in the step S21, that is, if the non-display operation is not performed, the processor 30 returns to the processing of the step S9. On the other hand, if “YES” is determined in the step S9, that is, if the non-display operation is performed, the processor 30 returns to the processing of the step S1.

FIG. 10 is a flowchart of the cursor position control processing. When the step S13 is performed in the sentence producing processing, the processor 30 determines, in a step S41, whether a single selectable unit is sandwiched by the cursors C. It is determined whether it is rendered in a state where a single character is sandwiched by a first cursor C1 and a second cursor C2 as shown in FIG. 4(D), for example. In addition, in the processing of the step S41, determination is performed based on the character string that is stored in the selection buffer 332.

If “NO” is determined in the step S41, that is, if the number of characters that are selected by the cursors are two or more, for example, the processor 30 performs cursor moving processing in a step S43. If the cursor moving processing is performed, for example, the processor 30 determines whether a drag operation is performed to the cursor C, and if the drag operation is performed, the processor 30 moves the displaying position of the cursor C according to the drag operation.

Subsequently, the processor 30 determines, in a step S45, whether the editing operation is performed. That is, it is determined whether a touch is performed to a selected range in order to display the popup P2 including the editing processing. If “YES” is determined, that is, if the editing operation is performed, the processor 30 terminates the cursor position control processing, and then, returns to the sentence producing processing. Then, the editing processing of the step S15 is performed. On the other hand, if “NO” is determined in the step S45, that is, if not the editing operation, the processor 30 returns to the processing of the step S41.

If “YES” is determined in the step S41, that is, if a single character is sandwiched by the cursors C, for example, the processor 30 determines, in a step S47, whether a touch is performed. That is, it is determined whether the touch flag 340 is turned on. If “NO” is determined in the step S47, that is, if a touch is not performed, the processor 30 repeats the processing of the step S47. If “YES” is determined in the step S47, that is, if a touch is performed, the processor 30 determines, in a step S49, whether an editing operation is performed, as similar to the step S45. If “YES” is determined in the step S49, that is, if an editing operation is performed, the processor 30 terminates the cursor position control processing, and then, returns to the sentence producing processing.

On the other hand, if “NO” is determined in the step S49, that is, if an editing operation is not performed, the processor 30 determines, in a step S51, whether a slide in the rightward direction is performed. It is determined whether the rightward direction flag 344 is turned on.

If “YES” is determined in the step S51, that is, if a slide in the rightward direction is performed at an arbitrary position as shown in FIG. 5(A), the processor 30 fixes the first cursor C1 in a step S53. A touch operation to the first cursor C1 is invalidated, for example. In addition, the processor 30 performing the processing in the step S53 functions as a first fixing module.

Subsequently, the processor 30 moves the second cursor C2 in the rightward direction. That is, a moving amount of the second cursor C2 is calculated based on a moving amount of the slide, and the processor 30 moves the displaying position of the second cursor C2 based on the moving amount calculated. In addition, the processor 30 performing the processing in the step S55 functions as a first moving module.

Subsequently, the processor 30 determines, in a step S57, whether the slide is continued. If “YES” is determined in the step S57, that is, if the slide is continued, the processor 30 returns to the processing of the step S55. If “NO” is determined in the step S57, that is, if the finger of the user is not slid, for example, the processor 30 determines, in a step S59, whether the touch is released. That is, it is determined whether the touch flag 340 is turned off. If “NO” is determined in the step S59, that is, if the user does not release the finger from the touch panel 16, the processor 30 returns to the processing of the step S57. If “YES” is determined in the step S59, that is, if the user releases the finger from the touch panel 16 after the slide is ended, the processor 30 proceeds to processing of a step S71.

Furthermore, if “NO” is determined in the step S51, that is, if a slide in the rightward direction is not performed, the processor 30 determines, in a step S61, a slide in the leftward direction is performed. That is, it is determined whether the leftward direction flag 342 is turned on. If “NO” is determined in the step S61, that is, if neither a slide in the rightward direction nor a slide in the leftward direction is performed, the processor 30 returns to the processing of the step S41.

If “YES” is determined in the step S61, that is, if a slide in the leftward direction is performed as shown in FIG. 6(A), for example, the processor 30 fixes the second cursor C2 in a step S63, and moves the first cursor C1 in the leftward direction in a step S65. The processor 30 invalidates a touch operation to the second cursor C2, for example, and thereafter, moves the first cursor C1 in the leftward direction as shown in FIG. 6(B). In addition, the processor 30 performing the processing in the step S63 function as a second fixing module, and the processor 30 performing the processing in the step S65 function as a second moving module.

Subsequently, the processor 30 determines, in a step S67, whether the slide is continued. If “YES” is determined in the step S67, that is, if the slide is continued, the processor 30 returns to the processing of the step S65. If “NO” is determined in the step S67, that is, if the slide is not continued, the processor 30 determines, in a step S69, whether the touch is released. If “NO” is determined in the step S69, that is, if the finger is not released, the processor 30 returns to the processing of the step S67. If “YES” is determined in the step S69, that is, if released, the processor 30 proceeds to processing of a step S71.

In the step S71, the processor 30 cancels fixing of the cursor C. Invalidation of a touch operation to the first cursor C1 is canceled, for example. Then, if the processing of the step S71 is completed, the processor 30 returns to the processing of the step S41.

### Second Embodiment

In the second embodiment, if a touch position is overlapped with a displaying position of a cursor C that is not fixed when a slide operation is performed, the cursor C is made to move the touch position. In addition, since structure and fundamental operation of a mobile phone 10 are approximately the same as those of the first embodiment, a detailed description thereof is omitted.

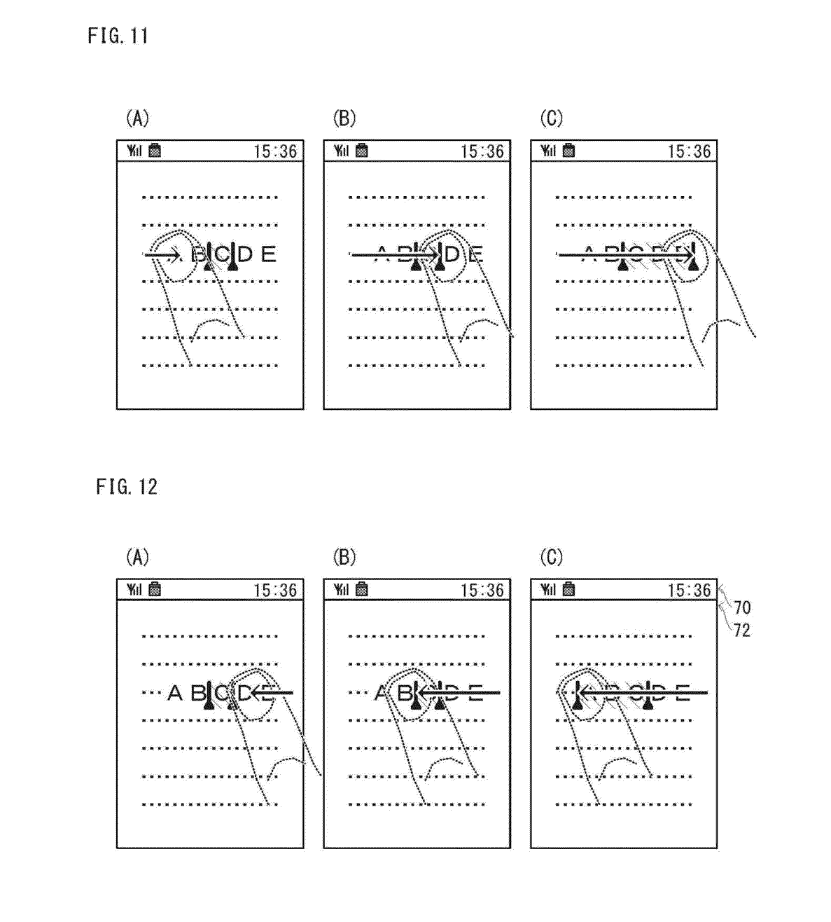

With reference to FIGS. 11(A) to 11(C), if a slide in a rightward direction is performed in a state where a character string is selected, a displaying position of a first cursor C1 is fixed. Then, if a touch position is overlapped with a displaying position of a second cursor C2, the second cursor C2 is moved to a current touch position. If the slide is continuously performed, the second cursor C2 follows the slide to change the displaying position.

On the other hand, with reference to FIGS. 12(A) to 12(C), if a slide in a leftward direction is performed in a state where a character string is selected, a displaying position of a second cursor C2 is fixed. Then, if a touch position is overlapped with a displaying position of a first cursor C1, the first cursor C1 is moved to a current touch position. Then, if the slide is continuously performed, the first cursor C1 follows the slide to change the displaying position.

That is, in the second embodiment, if a slide in a leftward direction or a slide in a rightward direction is performed, a touch operation to a cursor C that cannot be moved in that direction is invalidated, and only the other cursor C can be dragged.

Therefore, the user can drag only a necessary cursor C in approximately the same feelings as those of a usual cursor operation.

In addition, in other embodiments, the first cursor C1 or the second cursor C2 may not be moved to the touch position. That is, the user can move the cursor C to an arbitrary position by performing the slide such that the arbitrary position becomes an end point of the slide.

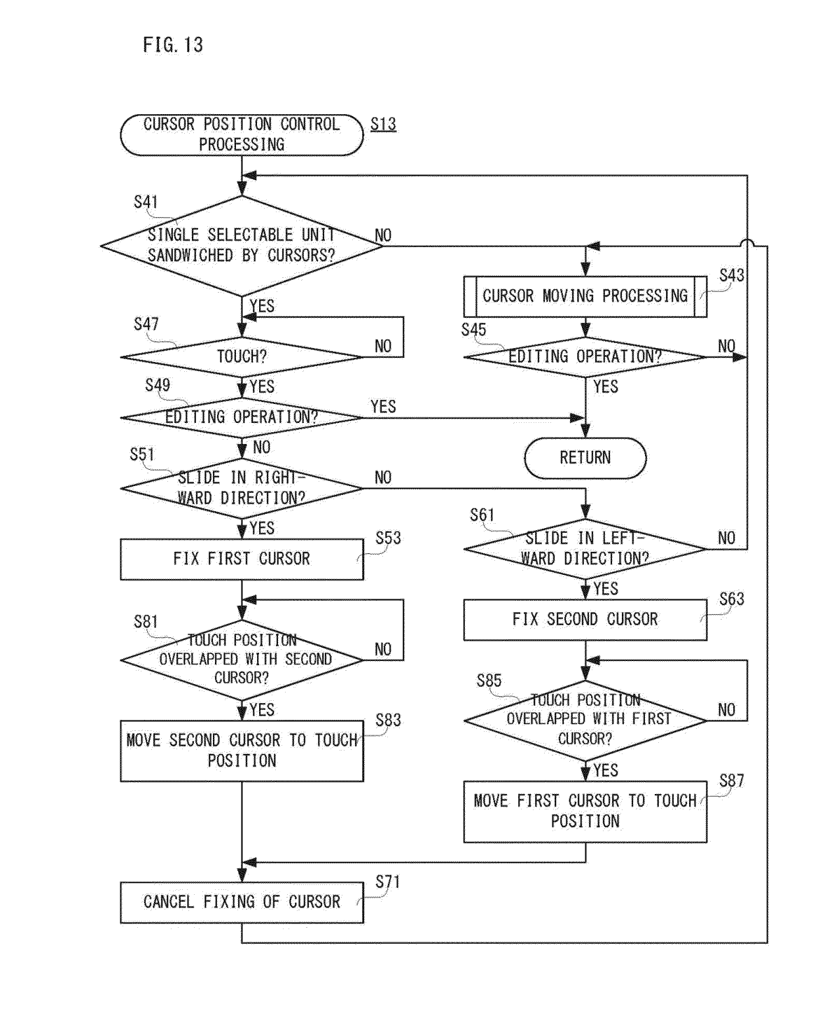

Although the feature of the second embodiment is outlined in the above, in the following, the second embodiment will be described in detail using a flowchart for the second embodiment shown in FIG. 13.

FIG. 13 is a flowchart of cursor position control processing in the second embodiment. As similar to the first embodiment, when the step S13 is performed in the sentence producing processing, the cursor position control processing in the second embodiment is started. The steps S41 to S51 are the same as those of the first embodiment, and therefore, a detailed description is omitted.

If “YES” is determined in the step S51, that is, if a slide in the rightward direction is performed, the processor 30 fixes the first cursor C1 in the step S53, and determines, in a step S81, whether a touch position is overlapped with the second cursor C2. That is, the processor 30 determines whether the coordinate of the touch position recorded in the touch buffer 330 is included within a displaying coordinate range of the second cursor C2 in the cursor coordinate data 338. “If “NO” is determined in the step S81, that is, if the touch position is not overlapped with the second cursor C2, the processor 30 repeats the processing of the step S81.

If “YES” is determined in the step S81, that is, if the touch position is overlapped with the displaying position of the second cursor C2 as shown in FIG. 11(B), for example, the processor 30 moves the second cursor C2 to the touch position in a step S83. For example, the processor 30 changes the displaying coordinate range of the second cursor C2 such that the basis coordinate of the second cursor C2 included in the cursor coordinate data 338 is coincident with the touch position stored in the touch buffer 330. Then, if the processing of the step S83 is completed, the processor 30 cancels fixing of the second cursor C2 in the step S71, and then, returns to the processing of the step S43. That is, the displaying position of the second cursor C2 becomes changeable by a drag operation. In addition, the processor 30 performing the processing in the step S83 functions as a first moving module.

Furthermore, if “YES” is determined in the step S61, that is, if a slide in the leftward direction is performed, the processor 30 fixes the second cursor C2 in the step S63, and determines, in a step S85, whether a touch position is overlapped with the first cursor C1. If “NO” is determined in the step S85, that is, if the touch position is not overlapped with the first cursor C1 as shown in FIG. 12(A), for example, the processor 30 repeats the processing of the step S85.

If “YES” is determined in the step S85, that is, if the touch position is overlapped with the first cursor C1 as shown in FIG. 12(B), for example, the processor 30 moves the first cursor C1 to the touch position in a step S87. Then, if the processing of the step S87 is completed, the processor 30 cancels fixing of the second cursor C2 in the step S71, and then, returns to the processing of the step S43. Accordingly, the displaying position of the first cursor C1 becomes changeable by a drag operation. In addition, the processor 30 performing the processing in the step S87 functions as a second moving module.

In addition, in other embodiments, a single selectable unit may be a single clause or a single word rather than a single character.

In other embodiments, the steps S41 to S45 may be omitted. That is, even though a character string being in a selected state is more than a single selectable unit (a single character), if a slide operation is performed, one of the first cursor C1 and the second cursor C2 may be fixed and the other may be moved.

Furthermore, not limited to the sentence producing function, a character string may be selected and a selected ranged may be adjusted as done in the above-described embodiments also in a browsing function for browsing Web site, a mail function (including SMS function) that a received mail is confirmed and a new mail is produced, a telephone dictionary function that a mail address, telephone number, etc. are displayed.

The programs used in the embodiments may be stored in an HDD of the server for data distribution, and distributed to the mobile phone 10 via the network. A plurality of programs may be stored in a storage medium such as an optical disk of CD, DVD, BD (Blu-ray Disc) or the like, a USB memory, a memory card, etc., and then, such the storage medium may be sold or distributed. In a case where the programs downloaded via the above-described server or storage medium are installed to a portable terminal having the structure equal to the structure of the embodiments, it is possible to obtain advantages equal to the advantages according to the embodiments.

The specific numerical values mentioned in this specification are only examples, and changeable appropriately in accordance with the change of product specifications.

It should be noted that reference numerals inside the parentheses and the supplements show an example of a corresponding relationship with the embodiments described above for easy understanding of the invention, and do not limit the invention.

A first embodiment is a portable terminal having a display module and a touch panel that is provided on the display module and detects a touch operation, wherein when dada that is being displayed on the display module is selected by a touch operation, selected data is sandwiched by a first cursor and a second cursor, comprising: a first fixing module operable to fix the first cursor when a touch operation moving in a first direction is performed in a state where the selected data is sandwiched by the first cursor and the second cursor; and a first moving module operable to move the second cursor when the touch operation moving in the first direction is performed in a state where the first cursor is fixed.

In the first embodiment, the portable terminal (10: reference numeral exemplifying a portion or module corresponding in the embodiment, and so forth) has the display module (14), the touch panel (16) that detects a touch operation, etc. A sentence that can be arbitrarily selected, for example is displayed on the display module as selectable data. If the user performs a selection operation, it is rendered in a state where a character string is sandwiched by the first cursor (C1) and the second cursor (C2).

If the selected data is a character, for example, the first fixing module (30, S53) fixes the first cursor when a touch operation moving in the first direction (rightward direction or leftward direction) is performed in a state where a single character is sandwiched by the first cursor and the second cursor. Furthermore, if the touch operation moving in the first direction is continued after the first cursor is fixed, the second cursor is moved in the first direction.

According to the first embodiment, the user can arbitrarily designate a range of the selected data because a position of the second cursor can be easily changed.

A second embodiment further comprises a second fixing module operable to fix the second cursor when a touch operation moving in a second direction is performed in the state where the selected data is sandwiched by the first cursor and the second cursor; and a second moving module operable to move the first cursor in the second direction when a touch operation moving in the second direction is performed in the state where the selected data is sandwiched by the first cursor and the second cursor.

In the second embodiment, the second fixing module (30, S63) fixes the second cursor when a touch operation moving in the second direction (leftward direction or rightward direction) opposite to the first direction is performed in a state where a single character is sandwiched by the first cursor and the second cursor. Furthermore, if the touch operation moving in the second direction is continued after the second cursor is fixed, the first cursor is moved in the second direction.

According to the second embodiment, the user can move the two cursors individually.

In a third embodiment, the first moving module is operable to move the second cursor to a current touch position when the touch operation moving in the first direction is performed in the state where the selected data is sandwiched by the first cursor and the second cursor, and the second moving module is operable to move the first cursor to a current touch position when the touch operation moving in the second direction is performed in the state where the selected data is sandwiched by the first cursor and the second cursor.

In the third embodiment, if the touch position is overlapped with the displaying position of the second cursor when the touch operation moving in the first direction is performed in the state where a single character is sandwiched by the first cursor and the second cursor, for example, the second cursor moves to the current touch position. On the other hand, if the touch operation moving in the second direction is performed and the touch position is overlapped with the displaying position of the first cursor, the first cursor moves to the current touch position.

According to the third embodiment, the user can drag only a necessary cursor in approximately the same feelings as those of a usual cursor operation.

In a fourth embodiment, the first fixing module is operable to fix the first cursor when number of the selected data that is sandwiched by the first cursor and the second cursor is one.

In the fourth embodiment, the first fixing module fixes the first cursor if the selected data is a character and a single character is sandwiched by the first cursor and the second cursor.

A fifth embodiment is a portable terminal (10) having a display module (14) and a touch panel (16) that is provided on the display module and detects a touch operation, wherein when dada that is being displayed on the display module is selected by a touch operation, selected data is sandwiched by a first cursor (C1) and a second cursor (C2), comprising: a first moving module (30, S55, S83) operable to move only the second cursor in a first direction when a touch operation moving in the first direction (rightward direction) is performed in a state where the selected data (a single character) is sandwiched by the first cursor and the second cursor; and a second moving module (30, S65, S87) operable to move only the first cursor in a second direction when a touch operation moving in the second direction (leftward direction) is performed in a state where the selected data is sandwiched by the first cursor and the second cursor.

According to the fifth embodiment, the user can arbitrarily designate a range of the selected data because a position of the second cursor can be easily changed.

A sixth embodiment is a cursor position control method in a portable terminal (10) having a display module (14) and a touch panel (16) that is provided on the display module and detects a touch operation, wherein when dada that is being displayed on the display module is selected by a touch operation, selected data is sandwiched by a first cursor (C1) and a second cursor (C2), a processor (30) of the portable terminal performing steps of: a fixing step (S53) operable to fix the first cursor when a touch operation moving in a first direction (rightward direction or leftward direction) is performed in a state where the selected data (a single character) is sandwiched by the first cursor and the second cursor; and a moving step (S55, S83) operable to move the second cursor in the first direction when the touch operation moving in the first direction is performed in a state where the first cursor is fixed.

According also to the sixth embodiment, as similar to the first embodiment, the user can arbitrarily designate a range of the selected data because a position of the second cursor can be easily changed.

Although the invention has been described and illustrated in detail, it is clearly understood that the same is by way of illustrative and example only and is not to be taken by way of limitation, the spirit and scope of the invention being limited only by the terms of the appended claim.

### DESCRIPTION OF NUMERALS

10—mobile phone

14—display

16—touch panel

30—processor

40—input device

44—flash memory

46—RAM

1. A portable terminal comprising:
display module and that displays data;
a touch panel that is provided on the display module and detects a touch operation; and
a control module operable to display, when data being displayed on the display module is selected by a touch operation, a first cursor and a second cursor so as to sandwich selected data, and move only the second cursor out of the first cursor and the second cursor in a first direction if a touch position is detected at a position different from displaying positions of the first cursor and the second cursor moves in the first direction.

2. The portable terminal according to claim 1,
wherein the control module is operable to move only the first cursor out of the first cursor and the second cursor in a second direction if a touch position is detected at a position different from displaying positions of the first cursor and the second cursor and moves in the second direction.

3. The portable terminal according to claim 1, wherein the control module is operable to start movement of the second cursor if the touch position moves in the first direction and becomes to coincide with the displaying position of the second cursor.

4. (canceled)

5. (canceled)

6. A cursor position control method in a portable terminal having a display module and a touch panel comprising steps of:
displaying data on the display module;
detecting a touch operation by a user;
displaying, when the data is selected by a touch operation, a first cursor and a second cursor so as to sandwich selected data; and
moving only the second cursor out of the first cursor and the second cursor in a first direction if a touch position is detected at a position different from displaying positions of the first cursor and the second cursor and moves in the first direction.

7. The portable terminal according to claim 2, wherein the control module is operable to start movement of the first cursor when the touch position is coincident with the displaying position of the first cursor if the touch position is being moved in the second direction.

8. The portable terminal according to claim 1, wherein the control module is operable to move only the second cursor out of the first cursor and the second cursor in the first direction when a touch position is moved in the first direction if the touch position is detected at a position different from the displaying positions of the first cursor and the second cursor in an area different from an area of the selected data.

9. The portable terminal according to claim 2, wherein the control module is operable to move only the first cursor out of the first cursor and the second cursor in the second direction when a touch position is moved in the second direction if the touch position is detected at a position different from the displaying positions of the first cursor and the second cursor in an area different from an area of the selected data.

10. The portable terminal according to claim 2, wherein the first direction is a direction toward the second cursor from the first cursor, and the second direction is a direction toward the first cursor from the second cursor.

11. The portable terminal according to claim 1, wherein the data comprises character data.
